(19) United States
(12) Patent Application Publication
(10) Pub. No.: US 2009/0293212 A1
(43) Pub. Date: Dec. 3, 2009

(54) ELECTRIC TOOTHBRUSH/FLOSSER

(76) Inventor: Mitch Junkins, Newport Beach, CA (US)

Correspondence Address: Rutan & Tucker, LLP., 611 ANTON BLVD, SUITE 1400, COSTA MESA, CA, 92626, US

(21) Appl. No.: 12/296,257

(22) PCT Filed: Apr. 11, 2007
(86) PCT No.: PCT/US07/08991

§ 371 Date: Aug. 17, 2009

Related U.S. Application Data
(60) Provisional application No. 60/793,266, filed on Apr. 18, 2006.

(51) Int. Cl. A46B 13/00; A61C 15/00

(52) U.S. Cl. 15/22.1; 132/327

(57) ABSTRACT

An oral care device has a drive shaft with an eccentrically revolving proximal end. A socket or other member constrains an intermediate position of the drive shaft such that both ends of the drive shaft tend to revolve. Depending on the particular design, the drive shaft may also rotate about its own axis while the ends are revolving. The constraining member may be user adjustable in a manner that alters the amplitude of movement of the drive shaft at the head end.

### FIELD OF THE INVENTION

The field of the invention is electric toothbrushes and flossing devices. More specifically, the present invention relates to a new electronic toothbrush having greater head speeds.

### BACKGROUND OF THE INVENTION

The common toothbrush is a mainstay in today's society. It is considered a necessary part of dental and physical hygiene. Additionally, in order to maintain tooth form and avoid decay, the toothbrush and toothpaste have been used to promote the same. Typical traditional prior art toothbrushes required manual manipulation of the brush in the user's mouth. Additionally, it required the user to use enough force to agitate and displace particulates. This type of prior art toothbrush could be very cumbersome and tended to lead to inadequate cleansing and oral hygiene. Additionally, the use of a toothbrush did not clean between the teeth, requiring the separate use of a hand-held floss that would have to be manually manipulated by the user before or after use of the toothbrush. Later developments were toothbrushes that allowed for electrical automatic manipulation of the brush. These electrical toothbrushes tend to have spinning or revolving heads that provide the agitation that the user is sometimes not capable of or forgets to utilize.

Generally, there are two types of automatic electric toothbrushes and flossers. One type of automatic electrical toothbrushes are those in which the head spins or travels more than approximately 1 mm. These types of electric toothbrushes are commonly known as rotational or translational devices. The second type are those in which the head moves less than or about 1 mm. These types of devices are typically referred to as vibrational devices. Both types of devices have adherents, and indeed there are advantages and disadvantages to both types of movements.

The known rotational and translational devices are typically gear driven, and therefore have a realistic upper speed of only tens or low hundreds of cycles per second. Such speeds are sufficient to clean teeth and gums, but fail to provide the massaging and plaque reducing effects achievable from higher (sonic) speeds.

The known vibrational devices provide much higher speeds, often in the 10-30 kilohertz range (tens of thousands of cycles per second). But the motion is essentially random, and quite small. In addition, vibrational devices typically develop the vibrational movement using an electrically powered eccentric weight located in the handle. That design tends to provide for low efficiency because the handle loses vibrational energy to the user's hand during use, and the source of the vibration is relatively far from the brush or floss. These problems exist regardless of whether the weight is rotated directly by a drive shaft, or whether it is driven magnetically.

One solution is to place the vibrational source inside the head. Disclosures along those lines were set forth in my previously filed United States provisional application No. 60/540866, and previously filed U.S. patent utility application Ser. No. 10/783276. While having considerable advantages over the prior art, those new devices still produce motion at the distal (head) end that is somewhat random and relatively small.

A need therefore exists for an improved electric toothbrush device and apparatus. Additionally, a need exists for an improved toothbrush device having mechanisms that produce larger motions at the distal end of the toothbrush. Moreover, a need exists for an improved electrical toothbrush whereby the toothbrush may provide both traditional toothbrush and flossing techniques while utilizing large motions at the distal end at greater speeds than the prior art electric toothbrush.

Further, a need exists for an improved electronic toothbrush wherein the vibrational source is inside the head and/or distal end of the toothbrush to provide better velocity and efficiency of the rotation means.

### SUMMARY OF THE INVENTION

The present invention provides methods and apparatus for a new and improved electronic toothbrush and/or flosser. The electronic toothbrush embodies an apparatus having one end of a drive shaft that is coupled to an operating head (toothbrush, flosser, etc), and the other end is eccentrically revolved about a central point. Additionally, the electronic toothbrush has an intermediate position of the drive shaft (between the two ends) that may be constrained so that both ends of the drive shaft tend to revolve.

To this end, in an embodiment of the present invention, an oral care product is provided. The oral care product has an operating head removably coupled to a housing and a drive shaft having a distal end that moves the head along a closed, substantially curved path, and a proximal end that is disposed to revolve about a center. Additionally, the oral care product has a motor that supplies power to eccentrically drive the proximal end about the center.

In an exemplary embodiment, the oral care product has a proximal end of the drive shaft that is eccentrically coupled to a spinning member at a pivot.

In an exemplary embodiment, the oral care product has a spinning member that is substantially disk shaped.

In an exemplary embodiment, the oral care product has a spinning member that is eccentrically weighted to produce a vibration that is imparted to the drive shaft.

In an exemplary embodiment, the oral care product has a spinning member that is eccentrically weighted to reduce a vibration that is imparted to the drive shaft.

In an exemplary embodiment, the oral care product has a pivot that comprises a pin.

In an exemplary embodiment, the oral care product has a drive shaft that rotates about an internal axis as it revolves about the center.

In an exemplary embodiment, the oral care product has 8. The product of claim 1 where the curved path is substantially circular.

In an exemplary embodiment, the oral care product has a socket positioned to constrain movement of the shaft at an intermediate position between the distal and proximal ends of the shaft.

In an exemplary embodiment, the oral care product has a socket that includes a flexible core that at least partially surrounds the intermediate position.

In an exemplary embodiment, the oral care product has a position of the socket on the handle that is adjustable by a user, and where such adjustment alters a characteristic of the curved path.

In an exemplary embodiment, the oral care product has a position of a socket on the handle that is adjustable by a user, and wherein such adjustment alters a characteristic of the curved path wherein the characteristic is an amplitude.

In an exemplary embodiment, the oral care product has a speed control that operates the motor at a plurality of different speeds.

In an exemplary embodiment, the oral care product has a head portion which comprises a length of floss.

In an exemplary embodiment, the oral care product has a head portion that comprises a removable floss cartridge.

In an exemplary embodiment, the oral care product has a splayer that increases tension of the floss wherein the cartridge is installed in the product.

In an exemplary embodiment, the oral care product has a head wherein the head comprises a brush.

In an exemplary embodiment, the oral care product has a head wherein the head comprises a plastic probe.

Depending on the particular design, the drive shaft may also rotate about its own axis while the ends are revolving.

In yet another aspect, the constraining position may be user adjustable, in a manner that alters the amplitude of movement of the drive shaft at the head end.

In an exemplary embodiment, an improved electric dental apparatus is provided.

Yet another exemplary embodiment of the present invention is to provide an improved electric dental apparatus whereby the dental apparatus may be used solely as a flossing tool.

Still another exemplary embodiment of the present invention is to provide an improved electric dental apparatus whereby the dental apparatus may be used solely as a toothbrushing tool.

Another exemplary embodiment of the present invention is to provide an improved electric dental apparatus whereby the dental apparatus may be used as a combination flossing and toothbrushing tool.

In an exemplary embodiment of the present invention, an improved electric dental apparatus may be provided whereby the dental apparatus may have a tongue scrubber portion.

Yet another exemplary embodiment of the present invention is to provide an improved electric dental apparatus whereby the dental apparatus may have a constraining position that may be user adjustable.

Still another exemplary embodiment of the present invention is to provide an improved electric dental apparatus whereby the dental apparatus may have a head portion and a drive shaft portion.

Another exemplary embodiment of the present invention is to provide an improved electric dental apparatus whereby the dental apparatus may have a motor to rotate the head.

In another exemplary embodiment of the present invention, an improved electric dental apparatus may be provided whereby the dental apparatus may utilize a power means.

Still another exemplary embodiment of the present invention is to provide an 20 improved electric dental apparatus whereby the dental apparatus may utilize a power means whereby the power means may be a battery, may be plugged into a conventional wall outlet, may be magnetically charged, light powered, or any other suitable power source that would cause the dental apparatus to function under power.

Yet another exemplary embodiment of the present invention is to provide an improved electric dental apparatus whereby the dental apparatus may have a control button whereby the control button may be utilized by a user to activate and/or de-activate the unit.

In another exemplary embodiment of the present invention, an improved electric dental apparatus may be provided whereby the dental apparatus may have a rotating connector whereby the rotating connector is driven by a powered motor.

Still another exemplary embodiment of the present invention is to provide an improved electric dental apparatus that may have a disk provided to cause the rotation of the head portion about the base portion.

Another exemplary embodiment of the present invention is to provide an improved electric dental apparatus that may have a neck whereby the neck may accommodate a plurality of different head portions.

Yet another exemplary embodiment of the present invention is to provide an improved electric dental apparatus that may have a neck portion whereby the neck portion may accommodate a flossing tool.

In another exemplary embodiment of the present invention, an improved electric dental apparatus may be provided whereby the dental apparatus may have a neck portion that may accommodate a polishing tool.

Still another exemplary embodiment of the present invention is to provide an improved electric dental apparatus whereby the apparatus may have a neck portion that may accommodate a toothbrush tool.

Another exemplary embodiment of the present invention is to provide an improved electric dental apparatus that may have a neck portion whereby the neck portion may accommodate different tools for dental purposes including flossing, brushing, polishing, application of toothpaste and the like.

Yet another exemplary embodiment of the present invention is to provide an improved electric dental apparatus whereby the apparatus may have a drive shaft used to rotate and/or revolve the neck and head portions of the apparatus.

Still another exemplary embodiment of the present invention is to provide an improved electric dental apparatus that may have a handle that may be sized and shaped in any suitable manner for use by an individual.

Another exemplary embodiment of the present invention is to provide an improved electric dental apparatus that may have a floss cartridge contained therein for disbursement and use of floss material.

Yet another exemplary embodiment of the present invention is to provide an improved electric dental apparatus that may have a plurality of floss cartridges stored therein for dispensing floss when desired by a user.

A further exemplary embodiment of the present invention is to provide an improved electric dental apparatus that may have a floss cartridge that may be attached at the distal end of the neck of the apparatus.

In yet another exemplary embodiment, an improved electric dental apparatus may be provided wherein the apparatus may have a floss cartridge contained therein whereby a release mechanism may be provide for dispensing the floss cartridge when the apparatus runs out of floss.

Still another exemplary embodiment of the present invention is to provide an improved electric dental apparatus that may have a floss cartridge therein whereby the floss cartridge includes a body from which extends two tines and wherein the floss extends between the two tines.

Yet another exemplary embodiment of the present invention is to provide an improved electric dental apparatus that may have a spreader that may force separation of the tines from one another.

In yet another exemplary embodiment, an improved electric dental apparatus may be provided wherein the apparatus may have a spreader portion whereby the floss may extend from a first side of the spreader to a second side of the spreader.

A further exemplary embodiment of the present invention is to provide an improved electric dental apparatus that may have a socket whereby the socket connects the drive shaft to the neck portion of the apparatus.

In an exemplary embodiment of the present invention, an improved electric dental apparatus is provided whereby the apparatus may be constructed of any suitable material.

In yet another exemplary embodiment of the present invention, an improved electric dental apparatus may be provided whereby the apparatus may be constructed of plastic.

Yet another exemplary embodiment of the present invention is to provide an electric dental apparatus whereby the apparatus may allow for rotation of the distal end of the apparatus 360 degrees about the proximal end of the apparatus.

Still a further exemplary embodiment of the present invention is to provide an electric dental apparatus whereby the apparatus may allow for better cleaning of an individual user's oral elements.

Various objects, features, aspects and advantages of the present invention will become more apparent from the following detailed description of preferred embodiments of the invention, along with the accompanying drawings in which like numerals represent like components.

Additional features and advantages of the present invention are described herein, and will be apparent from the detailed description of the presently preferred embodiments and from the drawings.

### BRIEF DESCRIPTION OF THE DRAWING

FIG. 1 is an exploded view of an inventive flosser.

FIG. 2 is a non-exploded view of the flosser of FIG. 1.

FIG. 3 is an exploded view of a floss cartridge in cooperation with a spreader on an alternative embodiment of the inventive flosser.

FIG. 4 is three different views of a prototype flosser.

FIGS. 5-7 depict alternative heads for the flosser handle.

### DETAILED DESCRIPTION

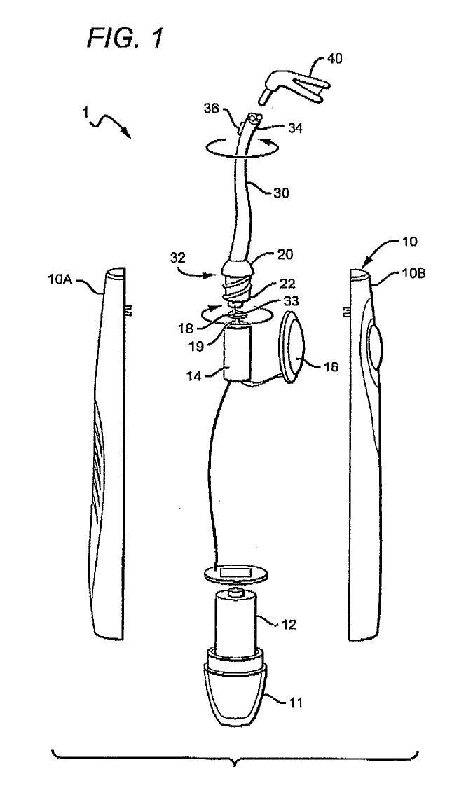

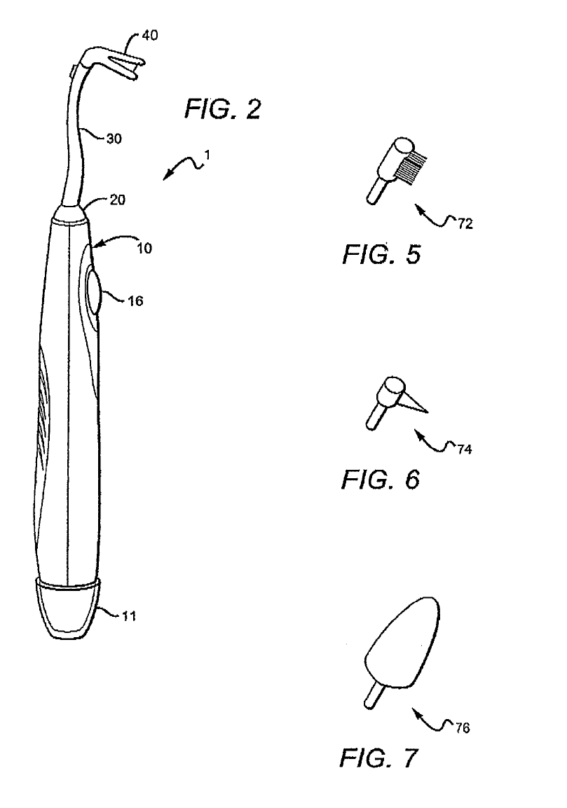

Turning now to the drawings wherein elements are identified by numbers and like elements are identified by like numbers throughout the 7 figures, the invention is depicted in FIG. 1 and illustrates a dental apparatus I that may be utilized by an individual to cleanse and promote dental health.

Referring now to FIG. 1, a dental apparatus 1 in the form of a flossing apparatus is provided. The dental apparatus 1 may have a handle 10, and a neck 60. Additionally, the dental apparatus may also have a socket 20, a drive shaft 30, and a floss cartridge 40.

In an exemplary embodiment, the handle 10 may generally include a first side 10A and a second side 10B. Additionally, the handle may have a battery 12 and a motor 14. Still further, the handle 10 of the dental apparatus 1 may also include a control button 16, and a rotating connector 18. Rotation of the connector 18 may be driven by motor 14, and controlled by button 16. The disk 18 is coupled to the proximal end 32 of the drive shaft 30 using a pin 33, such that rotation of the connector 18 causes the proximal end 32 of the drive shaft 30 to revolve about a center 19. The handle 10 of the dental apparatus may rest in optional removable stand 1. It should be noted that the handle described is only an exemplary embodiment of dental apparatus 1 and may be reconfigured in any desired way to produce the same result.

The handle 10 of the dental apparatus 1 may be sized and shaped in any suitable manner, however; in an exemplary embodiment, the handle 10 may be substantially tubular shaped as shown in the figures. In an exemplary embodiment, the dental apparatus 1 and handle 10 may be constructed of plastics. However, it should be understood that the dental apparatus 1 may be constructed of any material suitable for use by an individual. The handle 10 also may house the power source 12 which in an exemplary embodiment may be a battery which could be preferably user-replaceable, and/or inductively rechargeable according to known principles. The control button 16 can comprise a simple on-off switch, or can provide variable voltage/current to the motor. However, the power source 12 may be a conventional power source such as DC current in the form of a traditional plug-in apparatus. Additional power sources 12 are contemplated as are known in the art.

Connector 18 can be substantially round (i.e. disk shaped) as shown, or “I” shaped. However, the connector 18 may have any other suitable shape. The connector 18 may be balanced about its center 19 to reduce vibration and/or may be unbalanced to produce a desired amount of vibration. Connector 18 can have any desired weight from very light to relatively heavy, at which point it acts as a miniature flywheel.

Drive shaft 30 can connect to the connector 18 in any suitable manner, including the use of a simple pin 33 as shown. Another contemplated system uses a ball and socket (not shown), but indeed all suitable connection mechanisms are contemplated. Depending on the connection mechanism used, the drive shaft can be made to rotate about its own internal axis as it revolves about the center 19. These terms “rotate” and “revolve” are used in the sense of the local solar system, in which the earth rotates about its own axis as it revolves about the sun.

The neck 60 of the flosser 1 can either contain the drive shaft 30, or the neck can be the shaft 30.

Socket 20 has a lumen 22 that receives drive shaft 30 at a point or points intermediate of the proximal 32 and distal 34 ends of the drive shaft 30. Drive shaft 30 is preferably quite stiff, and the lumen 22 has a rubber, silicone or other resilient material 24 (not shown) disposed about the lumen 22 to accommodate what amounts to wobbling of the drive shaft 30 as it passes through the socket 20. Movement of the drive shaft 30 is thus constrained such that there is little wobbling motion of the drive shaft 30 at the point or points of constraint as compared with the ends 32, 24. The constrained point or points of the drive shaft 30 also function as a fulcrum, such that the proximal 32 and distal 34 ends of the drive shaft 30 move in opposite relationship. Thus, as the proximal end 32 of the drive shaft 30 moves generally in circles about the center 19 of the connector 18, the distal end 34 of the drive shaft 30 similarly move in circles.

Socket 20 can optionally be adjusted up or down the drive shaft 30, and in that manner alter the movement of the distal end 34 of the drive shaft 30. In general, the closer the socket 20 is to the connector 18, while still permitting rotation of the connector 18, the greater will be the motion of the distal end 34 of the drive shaft 30.

Those skilled in the art will appreciate that other means of constraining the motion of the drive shaft are likewise suitable. For example, motion of the drive shaft may be constrained by forming a ball on the drive shaft intermediate the ends thereof and by capturing the ball within a socket.

Floss cartridge 40 is attached at the distal end 34 of neck 30, and attached by a suitable mechanism. A release button 36 releases a used cartridge 40 for replacement.

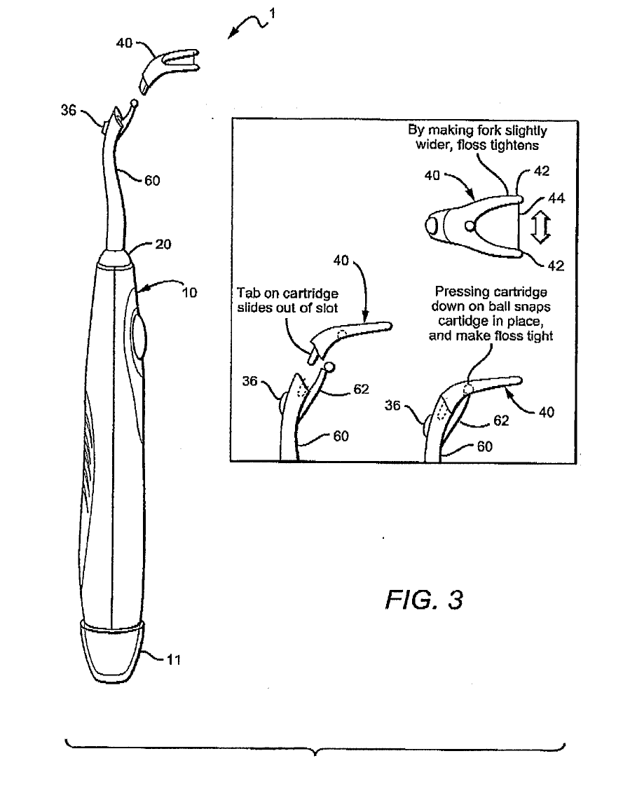

Referring now to FIG. 3, the floss cartridge 40 is shown. The floss cartridge 40 may include a body from which extends two tines 42. A length of floss 44 is affixed at its ends by the tines 42. In an exemplary embodiment of the apparatus 1, the neck 60 of the dental apparatus 1 may include a spreader 62 that forces separation of the tines 42 from one another. The three smaller images show sequentially how this operates.

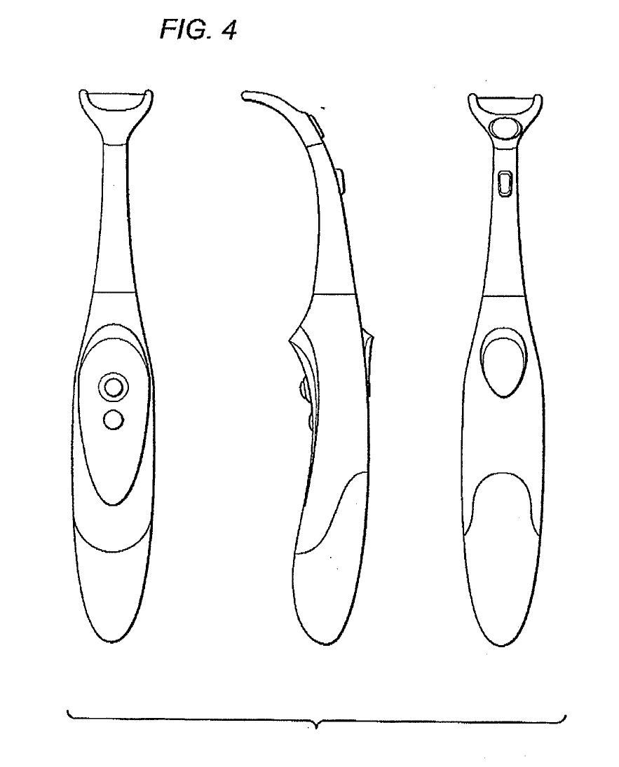

Those skilled in the art will also appreciate that floss cartridge 40 can be replaced by other oral care devices. It is contemplated that a plurality of different devices and/or tools may be utilized as illustrated in FIGS. 5-7, including for example, toothbrush tool 72, probe tool 74, tongue scraper tool 76, or indeed other flosser devices such as spooled floss holder (not shown). However, it should be understood that a plurality of different dental tools may be utilized and/or configured to be adaptable with the dental apparatus 1. Many or all such embodiments are expected to provide better 360-degree cleaning and reduced production costs, relative to the prior art.

Thus, specific embodiments and applications of the inventive subject matter have been disclosed. It should be apparent, however, to those skilled in the art that many more modifications besides those already described are possible without departing from the inventive concepts herein. The inventive subject matter, therefore, is not to be restricted to the embodiments disclosed herein. Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps can be present, or utilized, or combined with other elements, components, or steps that are not expressly referenced.

1. An oral care product comprising:
an operating head removably coupled to a housing;
a drive shaft having a distal end that moves the head along a closed, substantially curved path, and a proximal end that is disposed to revolve about a center;
a motor that supplies power to eccentrically drive the proximal end about the center.

2. The product of claim I wherein the proximal end of the drive shaft is eccentrically coupled to a spinning member at a pivot.

3. The product of claim 2 wherein the spinning member is substantially disk shaped.

4. The product of claim 2 wherein the spinning member is eccentrically weighted to produce a vibration that is imparted to the drive shaft.

5. The product of claim 2 wherein the spinning member is eccentrically weighted to reduce a vibration that is imparted to the drive shaft.

6. The product of claim 1 wherein the pivot comprises a pin.

7. The product of claim 1 where the drive shaft rotates about an internal axis as it revolves about the center.

8. The product of claim 1 where the curved path is substantially circular.

9. The product of claim 1 further comprising a socket positioned to constrain movement of the shaft at an intermediate position between the distal and proximal ends of the shaft.

10. The product of claim 9 wherein the socket includes a flexible core that at least partially surrounds the intermediate position.

11. The product of claim 9 wherein a position of the socket on the handle is adjustable by a user, and where such adjustment alters a characteristic of the curved path.

12. The product of claim 11 wherein the characteristic is an amplitude.

13. The product of claim 1 further comprising a speed control that operates the motor at a plurality of different speeds.

14. The product of claim 1 wherein the head comprises a length of floss.

15. The product of claim 14 wherein the head comprises a removable floss cartridge.

16. The product of claim 15 further comprising a splayer that increases tension of the floss wherein the cartridge is installed in the product.

17. The product of claim 1 wherein the head comprises a brush.

18. The product of claim 1 wherein the head comprises a plastic probe.
